(19) United States
(12) Patent Application Publication
(10) Pub. No.: US 2004/0237956 A1
(43) Pub. Date: Dec. 2, 2004

(54) Grill or barbecue

(76) Inventor: Oystein Helge Ljungmann, Siggerud (NO)

Correspondence Address: BANNER & WITCOFF, 1001 G STREET N W, SUITE 1100, WASHINGTON, DC, 20001, US

(21) Appl. No.: 10/481,021

(22) PCT Filed: Jun. 17, 2002
(86) PCT No.: PCT/NO02/00213

(30) Foreign Application Priority Data
Jun. 18, 2001 (NO) 20013010

(51) Int. Cl. A47J 37/00

(52) U.S. Cl. 126/30; 126/25 R

(57) ABSTRACT

Grill comprising a spherical bowl (1) for fuel as well as a tripod socket (2), the tripod socket (2) being formed with a U-shaped or circular arcuate portion (21) in which the bowl (1) may rest freely tiltable and that one leg (22) of the three legs carrying the tripod socket (2), protrude outwardly from the arcuate portion (21) in the symmetry plane (X-X) of the same and outwardly from the arc plane, whereas the other legs (23, 24) protrude outwardly from said portion and outwardly from the plane of the arc, at a distance from the first leg (22) and on each side of said symmetry plane (X-X).

The present invention is related to a grill or barbecue, especially adapted for use in holidays and leisure, on land and on water.

Many embodiments of grills are less user-friendly in undulated or sloping terrain or in a boat, which are natural basis of use. Some embodiments of the grills and especially so-called disposal grills or grills for one grill operation, also are very little environmental friendly as they represent danger for setting fire to or burning the underground, rock or vegetation and there also exists fire hazard. Furthermore, such disposable grills very easily are left where they are used and therefore represent a contamination danger.

Grills for use in gardens are made for level grounds. That is not so easy to find in the countryside, especially not where one also wishes to have stones or rocks to sit at. Then one usually has to accept that the grill is placed on a slanting way on a slope or a cliff, and watch it so that the sausages don't roll off or that the whole grill don't turn over.

The use of grills in the countryside has given room for a considerable market for once to be used grills. While such grills are made so low, they are not likely to overturn. But at the same time they are so close to the ground that they could easily hurt the vegetation were they are standing. In addition to this, used grills left in the nature makes an increasing problem of litter.

People in a boat have usually no problem finding a seat. But grilling on a boat could, however, be hazardous. As a matter of fact, there are grills in the market made to be hooked at the gunwale. But these grills cannot, however, be used at a side of a boat moored alongside a quay or alongside other boats, as well might happen in popular harbours. Should this type of grill be used ashore, one has to buy a special rack for that. And one is still left with the problem of levelling the grill on a stony beach.

The present invention provides a grill to be utilized on land as well as in a boat and which overcomes the disadvantages by known embodiments of grills.

The invention as such comprises a grill with a spherical segment all for the charcoal as well as a under-body having three legs, where the specific feature is the under-body made with a U-shaped or arcuate portion in which the bowl can rest freely tiltable, and that one of the three legs of the tripod socket protrudes outwardly from the U-shaped or arcuate portion in the symmetry plane of the same, whereas the other legs protrude from said portion at a distance from the first leg and on each side of said symmetry plane. As the tripod socket provides a three-point abutment against the ground, it will, as well known, always be stable in all different types of terrains or other grounds.

The bowl thereby resting freely tiltable in the U-shaped or arcuate portion and the bowl may be kept in a horizontal or substantially horizontal position independently of the slope of the ground.

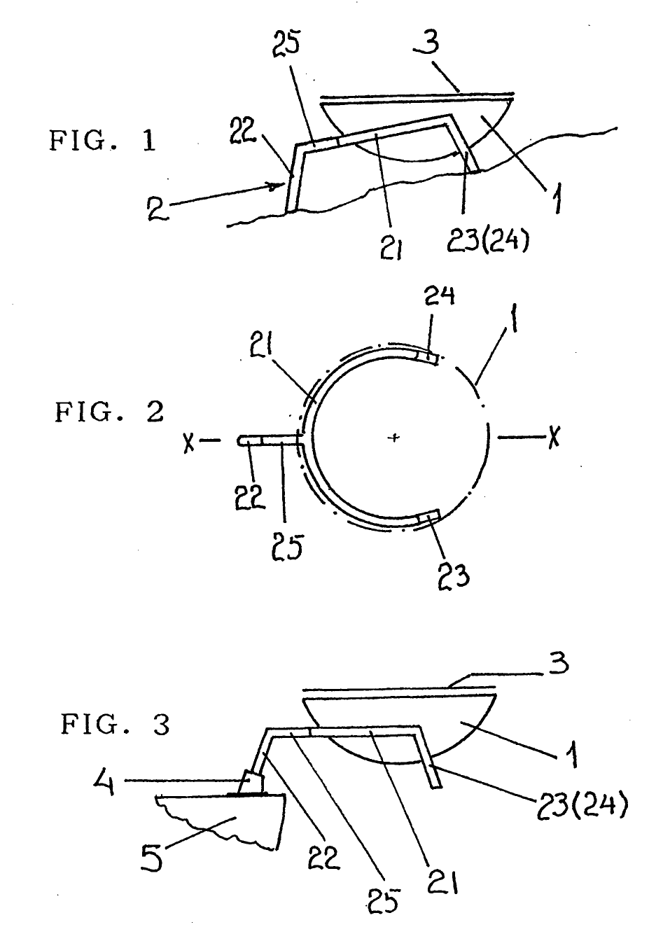

The present invention is more closely described with reference to the drawing disclosing examples of the range of use, and where FIG. 1 discloses a side view of a grill corresponding with the invention in a sloping terrain, FIG. 2 discloses a ground view of the grill in FIG. 1, in which the grill bowl only is indicated, and FIG. 3 discloses a side view of the grill in FIG. 1 installed in a holder for a flag staff on board a leisure boat, the grill thereby being installed outboard.

A grill according to the present invention and as disclosed in the drawing, comprises spherical segment bowl 1 for the fuel or charcoal, as well as a tripod socket 2. Above the opening in the fuel bowl 1, a grid 3 is arranged as well known, for placing products to be grilled. The bowl 1 and the grid 3 may in a well known fashion be equipped with a handgrip although not disclosed in the drawing.

The tripod socket 2 as disclosed in FIG. 2, is provided with an arcuate portion 21 in which the bowl 1 can rest freely tiltable, and one 22 of the three legs of the tripod socket, protrudes outwardly from the arcuated portion 21 in the symmetry plane X-X (FIG. 2) and outwardly from the plane of the arc whereas the two other legs 23 and 24 protrude outwardly from said portion 21 and out from the plane of the arc at a distance from the first leg 22 and on each side of said symmetry plane. The legs 22, 23 and 24 form suitably an angle larger than 90° with the plane for the portion 21. The legs need not branch off from the bowl carrying portion 21 directly, but may, as disclosed for the central leg 22, protrude outwardly from an arm 25 extending substantially radially outwardly from the arcuate portion 21.

The spherical segment bowl 1 is steady received in the arcuate portion 21 which as such is part of a circle. The stability of the bowl 1 placed in the arcuate portion 21 is defined by the friction between these two parts. The friction is again defined by the materials and the surfaces of the contact areas and of the pressure between them. The pressure can be increased to a sufficient size by increasing the radius of arcuate portion 21 and the bowl 1. It will then be possible to get such big pressure between the arcuate portion 21 and the bowl 1, that the latter has to be lifted up to change its position.

Should it then be needed to have such a big radius of the arcuate portion 21, that the bottom of the bowl 1 comes too low, the bowl 1 can be provided with a flat bottom. It is only significant that the bowl 1 is given a spherical form where it will be in contact with the arcuate portion 21.

As disclosed in FIG. 1, the grill bowl 1 and the corresponding grid 3 will be kept horizontally or substantially horizontally even if the grill is placed on a sloping ground.

When the legs 22-24 or at least the central leg 22, are correspondingly dimensioned, the grill tripod socket may be installed for example with one leg 22 in a flag staff 4 installed on a leisure boat 5 or on a terrace handrail in such a way that the grill may be used on such places without fire hazard as the grill is not placed directly under such structures, (for example the mast boom with sails, roof above terraces etc) which may be set into fire.

The grill according to the present invention also may be provided in a gas version, the arm 25 thereby being formed to receive a gas bottle.

Furthermore the bowl 1 may have a tetrahedron shape, the portion 21 thereby providing an equilateral triangle aperture in which the bowl 1 may be received in different desired positions.

1. Grill comprising a spherical bowl (1) for fuel as well as a tripod socket (2), characterized in the tripod socket (2) being formed with a U-shaped or circular arcuate portion (21) in which the bowl (1) may rest freely tiltable and that one leg (22) of the three legs carrying the tripod socket (2), protrude outwardly from the arcuate portion (21) in the symmetry plane (X-X) of the same and outwardly from the arc plane, whereas the other legs (23, 24) protrude outwardly from said portion and outwardly from the plane of the arc, at a distance from the first leg (22) and on each side of said symmetry plane (X-X).
